(19) United States
(12) Patent Application Publication
(10) Pub. No.: US 2008/0073434 A1
(43) Pub. Date: Mar. 27, 2008

(54) System and method for an image decoder with feedback

(76) Inventors: Alan J. Epshteyn, Miller Place, NY (US); Bradley Carlson, Huntington, NY (US); Paul Seiter, Port Jefferson Station, NY (US); Thomas F. Boehm, Medford, NY (US); Mark P. Orlassino, Centereach, NY (US)

Correspondence Address: FAY KAPLUN & MARCIN, LLP, 15O BROADWAY, SUITE 702, NEW YORK, NY, 10038, US

(21) Appl. No.: 11/527,118

(22) Filed: Sep. 26, 2006

(51) Int. Cl. G06K 7/10

(52) U.S. Cl. 235/454

(57) ABSTRACT

Describe is a computing device comprising an imaging arrangement, a processor and an output arrangement. The imaging arrangement obtains an image. The processor processes the image to determine a corresponding status of the image as a function of at least one predetermined decodability parameter. The output arrangement displays the image and a feedback signal of the corresponding status.

### FIELD OF THE INVENTION

The present application generally relates to systems and methods for providing feedback (e.g., visual and/or audible) by an imager-based decoder.

### BACKGROUND INFORMATION

Many mobile computing devices (e.g., scanners, PDAs, mobile phones, laptops, etc.) include digital cameras to extend their functionalities. For example, an imager-based barcode reader may utilize a digital camera for capturing images of barcodes, which come in various forms, such as parallel lines, patterns of dots, concentric circles, hidden images, etc.), both one dimensional (1D) and two dimensional (2D).

The imager-based barcode reader typically provides a display screen which presents a preview of an imaging field of the imager. Thus, a user may visually confirm that a barcode will be included in an image generated by the imager. Even though conventional decoders can locate and decode bar codes regardless of location within the image, users typically think that the barcode must be centered within the image for the barcode to be decoded properly. In addition, users typically think that the barcode must be large within the image to be decoded properly, and, as a result, place the imager-based barcode reader extremely close to the barcode. However, the conventional decoders can decode barcodes that are relatively small within the image. Therefore, between orienting the barcode in the display and manually zooming, capturing the image may prove to be unnecessarily time consuming.

### SUMMARY OF THE INVENTION

The present invention relates to a system, method and device for an image decoder providing feedback. The device comprises an imaging arrangement, a processor and an output arrangement. The imaging arrangement obtains an image. The processor processes the image to determine a corresponding status of the image as a function of at least one predetermined decodability parameter. The output arrangement displays the image and a feedback signal of the corresponding status.

### BRIEF DESCRIPTION OF THE DRAWINGS

FIG. 1 illustrates an exemplary embodiment of a system according to the present invention.

FIG. 2 illustrates an exemplary embodiment of a method for obtaining images according to the present invention.

FIG. 3 illustrates an exemplary embodiment of a method for obtaining images according to the present invention.

FIG. 4a illustrates an exemplary embodiment of image pre-processing according to the present invention.

FIG. 4b illustrates an exemplary embodiment of a display of an image according to the present invention.

FIG. 5a illustrates an exemplary embodiment of a display indicating a status of focus of an image according to the present invention.

FIG. 5b illustrates an exemplary embodiment of a display indicating focus of an image according to the present invention.

FIG. 5c illustrates an exemplary embodiment of an imaging device obtaining an image according to the present invention.

FIG. 5d illustrates an exemplary embodiment of a display screen showing a focused decodable object in a forefront of an image with an unfocused background.

FIG. 6 illustrates an exemplary embodiment of a display indicating that an image has been loaded according to the present invention.

FIG. 7 illustrates an exemplary embodiment of a display indicating the successful decode of an image according to the present invention.

FIG. 8 illustrates an exemplary embodiment of a display indicating decoded information according to the present invention.

FIG. 9 illustrates an exemplary embodiment of a display including one or more visual indicators according to the present invention.

### DETAILED DESCRIPTION

The present invention may be further understood with reference to the following description and appended drawings, wherein like elements are provided with the same reference numerals. The exemplary embodiments of the present invention describe a computing device which includes an imaging arrangement for capturing an image and an output arrangement for displaying the image. The computing device may perform some pre-processing of the image to enhance usability thereof, as will be explained below.

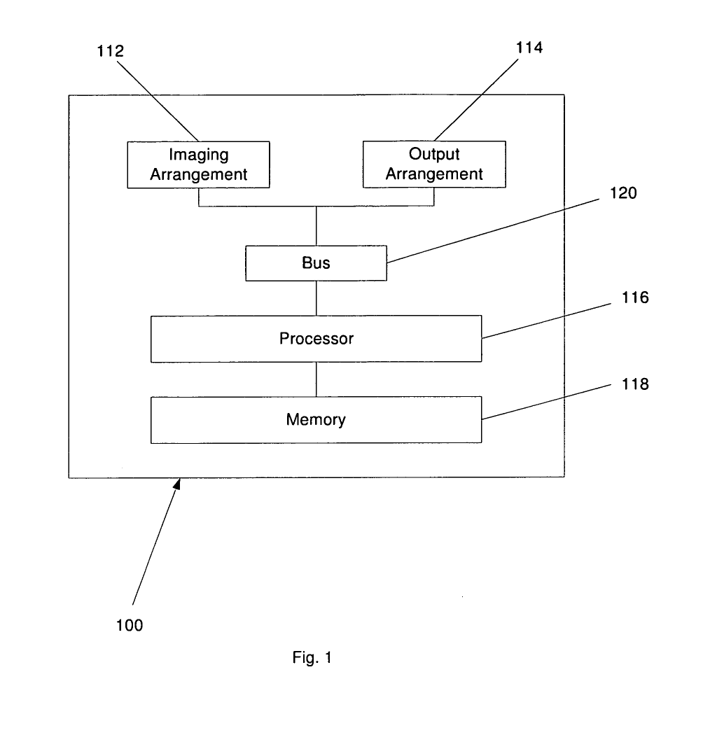

FIG. 1 illustrates an exemplary embodiment of a computing device 100 according to the present invention. The computing device 100 may be implemented as any processor-based device such as, for example, an imager-based scanner, an RFID reader, a mobile phone, a laptop, a PDA, a digital camera, a digital media player, etc. The device 100 comprises an imaging arrangement 112, an output arrangement 114, a processor 116, and a memory 118, which are interconnected via a bus 120. Those of skill in the art will understand that the device 100 may include various other components such as, for example, a wireless transceiver, touch screen, a keypad, etc. for accomplishing tasks for which the device 100 is intended. The components of the device 100 may be implemented in software and/or hardware.

The processor 116 may comprise a central processing unit (CPU) or other processing arrangement (e.g., a field programmable gate array) for executing instructions stored in the memory 118 and controlling operation of other components of the device 100. While the processor 116 is shown as included on the device 100, those of skill in the art will understand that the processor 116 may be part of a separate device which also includes the memory 118 and/or the output arrangement 114.

The memory 118 may be implemented in any combination of volatile memory, non-volatile memory and rewritable memory, such as, for example, Random Access Memory (RAM), Read Only Memory (ROM) and/or flash memory. The memory 118 stores instructions and data used to operate the device 100. For example, the memory 118 may comprise an operating system and a signal processing method (e.g., image capture method, image decoding method, etc.). The memory 118 may also store images previously captured by imaging arrangement 112.

The imaging arrangement 112 (e.g., a digital camera) may be used to capture an image (gray-scale or color) of the barcode. The output arrangement 114 (e.g., a liquid crystal display, a projection display, etc.) may be used to view a preview of the image prior to capture, the image as it is being captured and/or play back of previously captured images. In the exemplary embodiments, the output arrangement 114 may also display visual feedback indicating when the image contains a decodable image of the barcode, a status of a focus of the image of the barcode and/or whether a decode attempt on the image has been successful.

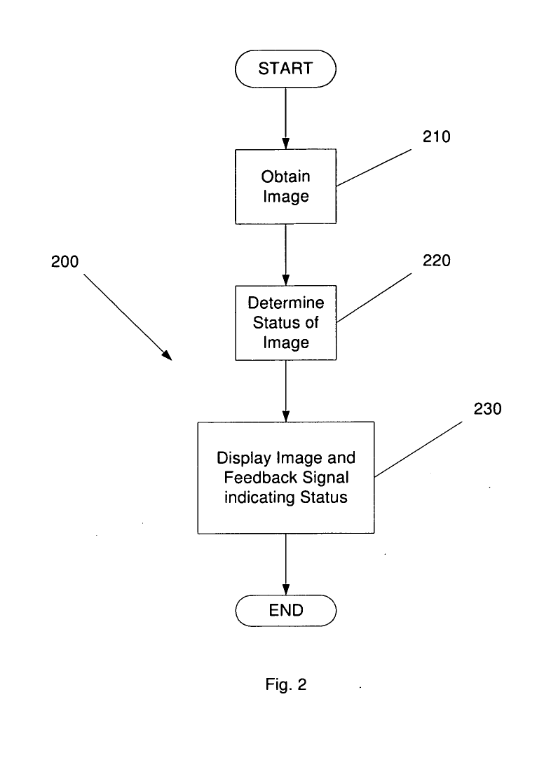

FIG. 2 shows an exemplary embodiment of a method 200 according to the present invention. In step 210, the imaging arrangement 112 obtains an image. In step 220, the processor 116 analyzes the image to determine a status thereof. The status of the image may indicate whether the image includes an image of a barcode and whether the image of the barcode is decodable based on, for example, size, contrast, ambient light, blur, focus, etc. In step 230, the image of the barcode is displayed on the output arrangement 114. The output arrangement 114 may also output a feedback signal indicative of the status of the image of the barcode. For example, the feedback may be a visual indicator indicating that the barcode is out-of-focus and too far from or close to the imaging arrangement 112 (i.e., too small/large within the image) to be decoded. Those of skill in the art will understand that the visual indicator may be a color-coding, an icon, a symbol, a graphic, etc. In another embodiment, the feedback signal may be an audible indicator which may be a tone (e.g., a beep) that varies in frequency, volume, etc. to indicate the status of the image of the barcode, as will be explained further below.

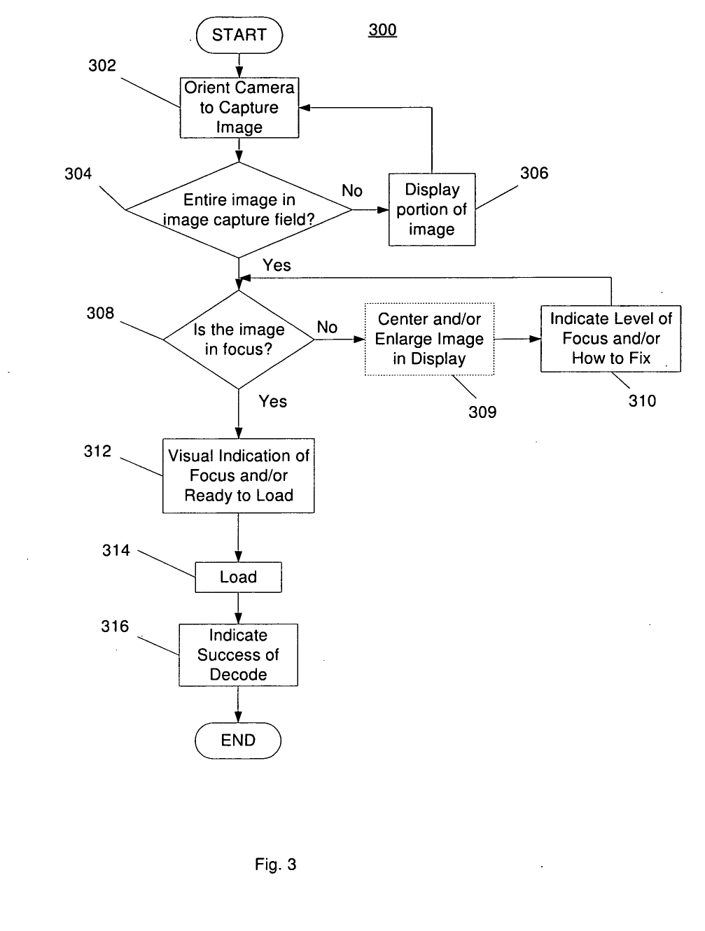

FIG. 3 illustrates an exemplary embodiment of a feedback method 300 according to the present invention. In step 302, the user aims the imaging arrangement 112 at an object (e.g., a barcode) to capture an image thereof. Generally, a position of the imaging arrangement 112 relative to the barcode may be determined by viewing an image of the barcode in an image generated on the output arrangement 114. For example, the output arrangement 114 may provide realtime preview images generated by the imaging arrangement 112. Thus, the user can simply view the preview images to gain an indication of where the barcode is located within the imaging field of the imaging arrangement 112 and whether the image would include the entire barcode so that it may be decoded.

In step 304, the processor 116 determines whether the entire barcode (or at least a portion of the barcode suitable for decoding) is included in the image capture field by analyzing the preview image(s). In step 306, the processor 116 determines that the entire barcode is not included in the preview image. Thus, the processor 116 may display a portion of the barcode on the output arrangement 114 so the user can reorient the device 100 relative to the barcode. Alternatively, the processor 116 may not display any portion of the barcode on the output arrangement 114 if the entire barcode is not in the field of view of the imaging arrangement 112.

In step 308, the entire barcode is in the preview image, so the processor 116 determines whether the image of the barcode 410 is sufficiently focused to be decoded. For example, high ambient light or an awkward imaging angle may result in a blurred and/or skewed image. In step 310, if the processor 116 determines that the image cannot be decoded, the processor 116 outputs a focus level indicator on the output arrangement 114. As understood by those of skill in the art, if the imaging arrangement 112 can be automatically focused, the processor 116 may automatically adjust a focus of the imaging arrangement 112 until the image is properly focused for decoding. When the imaging arrangement 112 has a fixed focus, the focus level indicator may be output on the output arrangement 114, indicating to the user that the image is not properly focused and that the device 100 may have to be manually reoriented relative to the barcode.

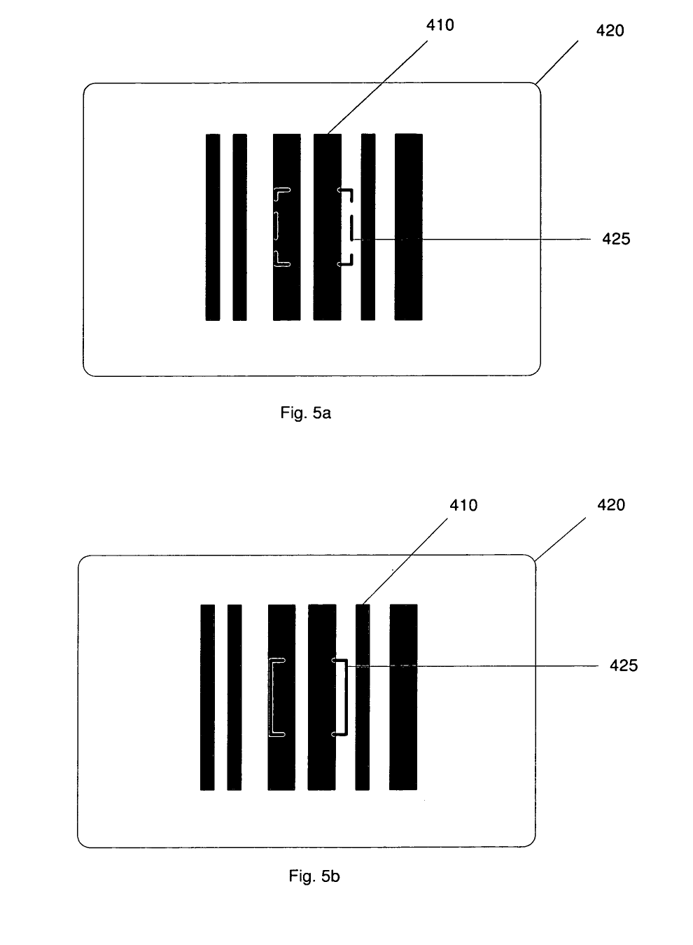

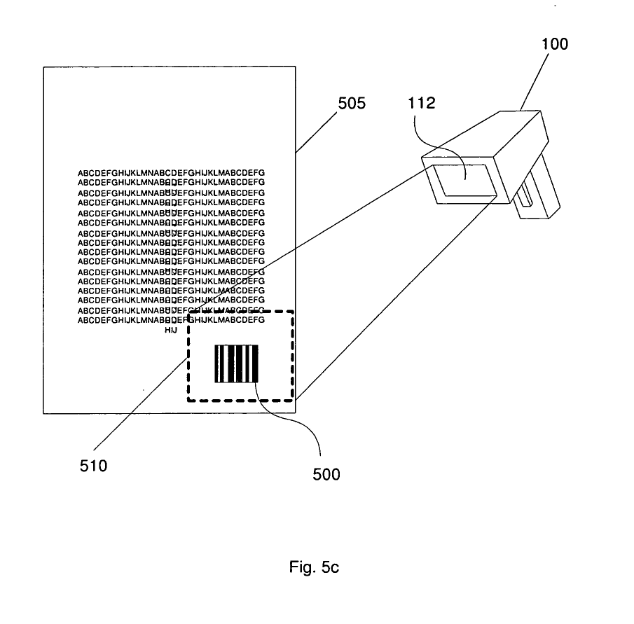

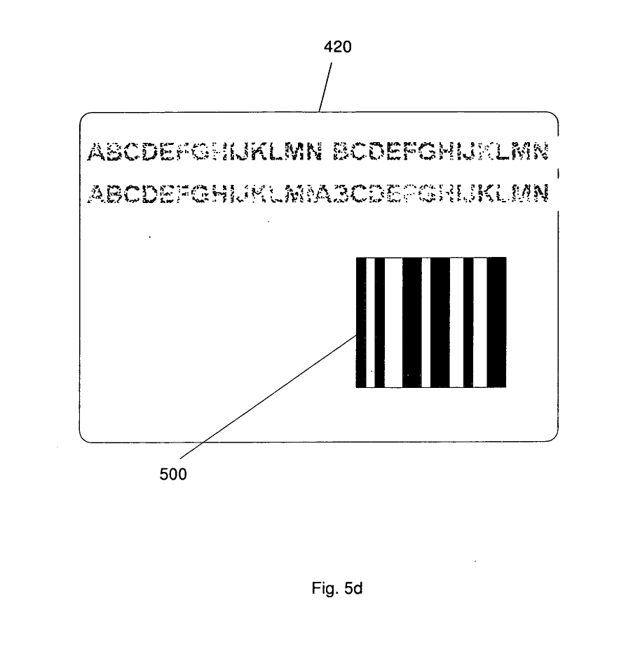

As shown in FIGS. 5a and 5b, the focus level indicator may include brackets 425 which flash or consist of broken lines (FIG. 5a) when the image is not decodable (out of focus) and become solid (FIG. 5b) when the image is decodable (focused). The user may reorient the device 100 to refocus the image (e.g., when the imaging arrangement is fixed focus). Alternatively, the processor 116 may refocus the imaging arrangement 112 automatically as a function of the decodability of the barcode 410 within the image. Those of skill in the art will understand that the focus level indicator is not limited to brackets but may be other visual indicators, for example, color coding, lights, icons, graphics, etc. displayed on the display screen 420 or audible indicators output by the device 100.

FIGS. 5c and 5d illustrate another exemplary embodiment of refocusing a decodable object within the image. As shown in FIG. 5c, the device 100 may be used to obtain an image of a barcode 500 disposed on an item 505. By properly orienting the device 100, the imaging arrangement 112 generates an image including the barcode 500. However, as shown in FIG. 5c, an image capture field 510 is larger, in area, than the barcode 500, so the image generated by the imaging arrangement 112 may also show a portion of the item 505. For example, if the item 505 is a book, the image generated by the imaging arrangement 112 may include, along with the barcode 500, text on a cover of the book and a portion of the cover of the book. According to this exemplary embodiment, the processor 116 may identify a decodable object within the image, e.g., the barcode 500, and refocus the imaging arrangement 112 to obtain a decodable image of the barcode 500 which is presented on the display screen 420. The image shown on the display screen 420 may include a focused image of the barcode 500 on an unfocused/blurry background. In this embodiment, the barcode 500 may or may not be centered within the image shown on the display screen 420.

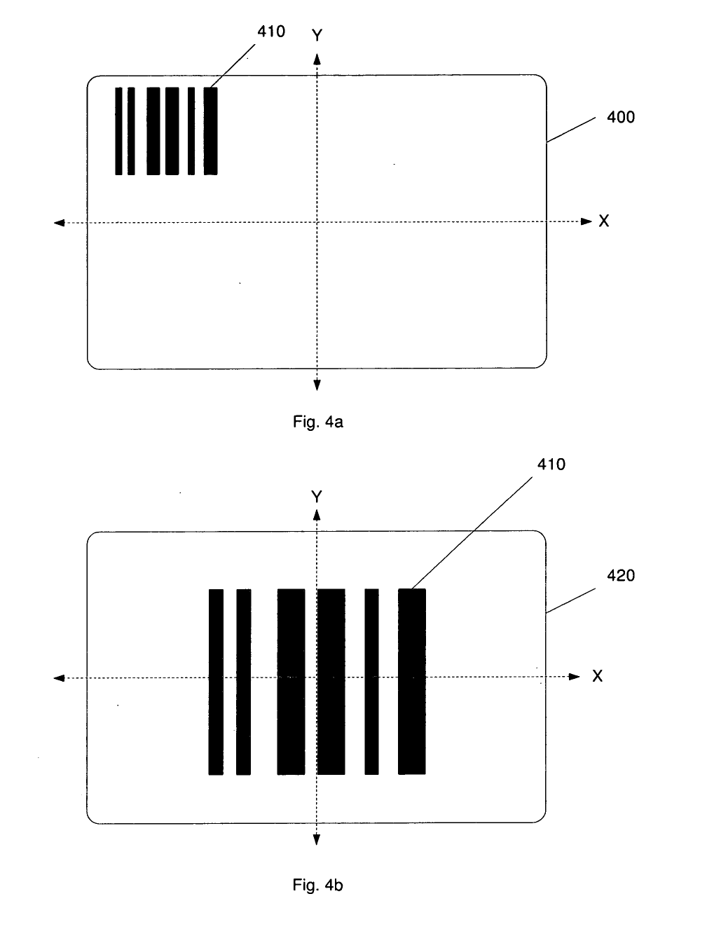

Prior to step 310, the method 300 may include an optional step 309 in which the processor 116 centers, reorients and/or enlarges the image of the barcode on the output arrangement 114. FIG. 4a shows an exemplary embodiment of an image capture field 400 of the imaging arrangement 112. For example, the user may be pointing the imaging arrangement 112 at an item to capture an image of and decode a barcode 410 on the item. According to the present invention, prior to decoding, the processor 116 performs some pre-processing on images generated by the imaging arrangement 112 to detect for the image of the barcode 410. For example, as shown in FIG. 4a, the barcode 410 is included in the image captured by the imaging arrangement 112, but is offset from a center thereof. When the barcode 410 is detected in the image, the processor 116 determines the status of the barcode 410 based on at least one decodability parameter, e.g., whether due to blur, ambient light, etc., the image of the barcode 410 can be decoded if captured. When the processor 116 determines that the barcode 410 is decodable, the barcode 410 is shown on a display screen 420 of the device 100, as shown in FIG. 4b. For example, the processor 116 may center, rotate to a predetermined orientation with respect to the display screen 420 and/or resize the image of the barcode 410 to a predetermined size (relative to dimensions of the display screen 420) for display on the display screen 420. In this manner, the user is assured that the entire barcode 410 will be captured and decoded. In other exemplary embodiments, the optional step 309 may be performed after the step 304, i.e., after the processor 116 has detected the barcode within the image.

In step 312, the processor 116 may provide an indicator on the display screen 420 that the barcode 410 is contained within the image and is properly focused for decoding (e.g., ready to be loaded into a decoding algorithm). In step 314, the imaging arrangement 112 captures and loads the image, because the user initiated an image capture by, for example, depressing a trigger on the device 100.

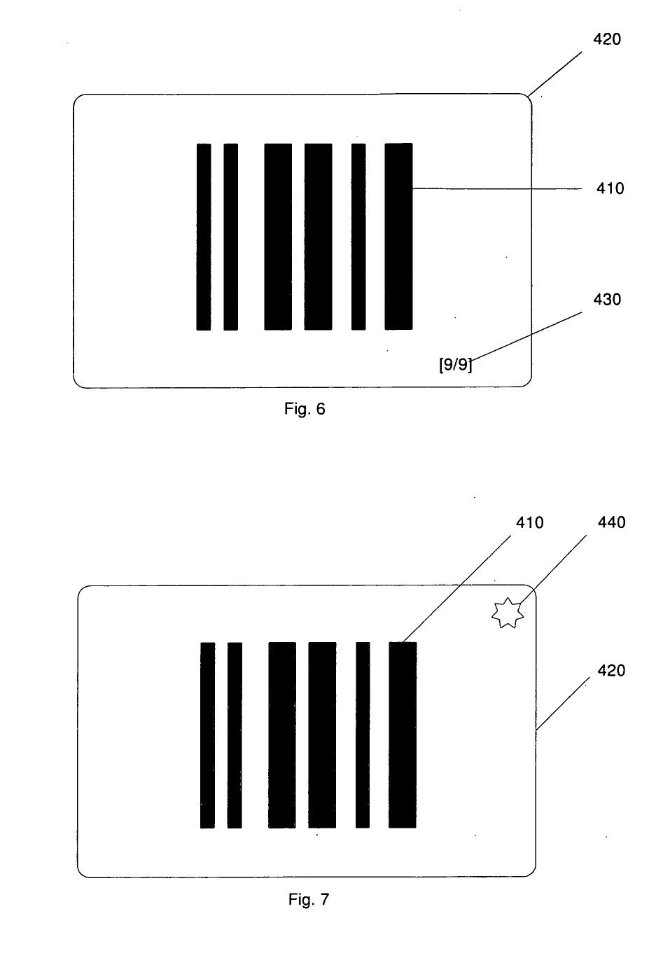

In step 316, the processor 116 may indicate whether a decode attempt on the image was successful by providing a decode feedback indicator. FIGS. 6 and 7 show exemplary embodiments of the decode feedback indicator presented on the display screen 420. However, those of skill in the art will understand that the decode feedback indicator may be audible or vibratory. In FIG. 6, the decode feedback indicator indicates that the image has been properly decoded by displaying a number of the image in the memory 118 relative to a total number of images stored in the memory 118. Thus, the user may compare the number of items scanned to a number of items on a task list. In FIG. 7, the success of the decode may be indicated by a graphic, an icon, a symbol, color coding, LED flashes, display screen contrast changes, etc. In FIG. 7, an icon 440 presented on the display screen 420 indicates a successful decoding attempt. It will be apparent to one of ordinary skill in the art that the icon 440 may take a variety of shapes, sizes, colors, etc.

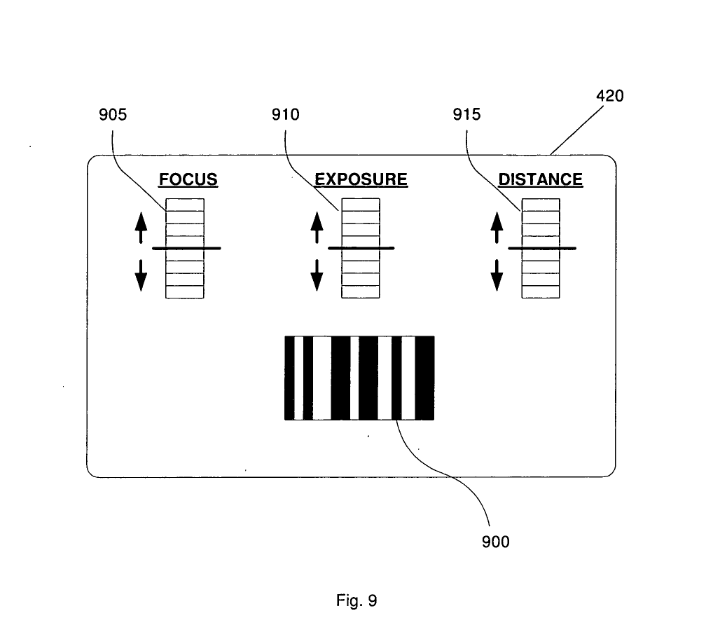

As stated above, the indicators provided by the device 100 from analysis of the images generated by the imaging arrangement 112 may correspond to one or more decodability parameters which include, but are not limited to, whether the barcode is focused in the image, whether the image is too bright/dark to be decoded, whether the barcode is too small/large within the image to be decoded, etc. In one exemplary embodiment, at least one indicator (visual and/or audible) corresponding to a respective decodability may be provided by the device 100. For example, as shown in FIG. 9, the display screen 420 may show an image containing a barcode 900. However, if the image is captured the barcode 900 may not be decodable due to, for example, blur, contrast, brightness/darkness levels, size, etc. Thus, a focus indicator 905, an exposure indicator 910 and/or a distance indicator 915 may be shown on the display screen 420 and updated in realtime by the processor 116. Each of the indicators 905-915 may include floating level which moves through each of the indicators 905-915 in response to signals from the processor 116 generated during analysis of the image. Each of the indicators 905-915 may include a reference range which indicates that the barcode 900 is decodable when the floating level is therein. For example, if the floating level moves out of the reference range for the distance indicator 915, the device 100 must be moved either closer to or farther away from the barcode 900 to obtain a decodable image. As the device 100 moves, the floating level may change positions on the indicator to provide feedback to the user.

As stated above, the images captured by the imaging arrangement 112 may include multiple barcodes. Thus, in another exemplary embodiment of the present invention embodiment, summary data corresponding to each of the barcode(s) may be overlaid on the image(s) of the barcode(s) presented on the display screen 420. In another embodiment, the summary data may be displayed on the display screen 420 replacing the image.

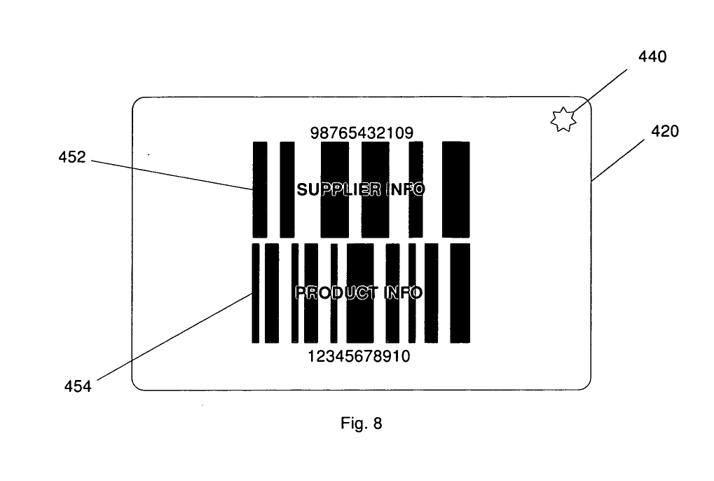

FIG. 8 shows an exemplary embodiment of the summary data displayed on the display screen 420. In the exemplary embodiment, the processor 116 has detected barcodes 452, 454 within the image. The processor 116 centers and/or enlarges the barcodes 452, 454 for display on the display screen 420. The processor 116 may further display numbers associated with each of the barcodes 452, 454 on or adjacent their corresponding images. The processor 116 may stack the barcodes 452, 454 vertically or horizontally, as desired. The processor 116 then displays the summary data for each of the barcodes 452, 454. The barcode 452 may contain supplier information while the barcode 454 may contain product information.

In another exemplary embodiment of the present invention, a window may be shown on the display screen 420 which is mapped one-to-one in image pixels to display pixels. For example, the imaging arrangement 112 may be a 1.3 megapixel imager (1280×960) and the display screen 420 may be a QVGA display (320×420). In this case, only 1/16 of the image pixels are displayed on the display screen 420. Due to this loss of pixel data, an image may appear focused on the display screen 420 but be out-of-focus in reality. Thus, the window shown on the display screen 420 may have a predetermined pixel resolution (e.g., about 80×80) in which a full resolution image is shown from a sampled resolution of a full field image obtained by the imaging arrangement 112. A user may simultaneously view an entire field of view so that the barcode can be properly framed and a true resolution so any blur in the image is accurately represented. This exemplary embodiment may be implemented as described above with reference to FIGS. 5c-d.

From the description of the exemplary embodiments, one of skill in the art would understand that the present invention allows an image to be targeted, captured, and decoded while providing intermittent real-time feedback to the user. For example, if a barcode is detected within the image capture field, the display screen will display the barcode thereon as centered and/or resized. Similarly, if an image is out of focus, visual feedback may be provided to the user via a display screen 420 through color coding, icons, graphics, symbols, etc.

An advantage of the present invention is that it allows a device with an imaging device to provide optimal scanning performance without projecting a targeting pattern onto an object to be captured. This may conserve power for the device. Another advantage of the present invention providing faster image capture and faster decoding and may lower costs by eliminating wasted time due to refocusing the device.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A computing device comprising:
an imaging arrangement obtaining an image;
a processor processing the image to determine a corresponding status of the image as a function of at least one predetermined decodability parameter; and
an output arrangement displaying the image and a feedback signal of the corresponding status.

2. The device according to claim 1, wherein the feedback signal includes at least one of a visual and an audible indicator.

3. The device according to claim 2, wherein the visual indicator includes at least one of a light flash, a color change, an icon, a symbol, a floating level over a displayed range and a number.

4. The device according to claim 2, wherein the audible indicator is a tone varying in at least one of frequency, volume and pitch.

5. The device according to claim 1, wherein the predetermined decodability parameter is at least one of (i) a parameter indicative of a focus level of the image, (ii) a parameter indicative of whether the entire image is within an image capture field of the imaging arrangement, (iii) a parameter indicative of whether the image is ready for further processing.

6. The device according to claim 5, wherein the parameter (iii) indicates whether the image is decodable.

7. The device according to claim 1, wherein the processor refocuses the displayed image as a function of the corresponding status.

8. The device according to claim 1, wherein the processor focuses at least a selected portion of the image leaving a remaining portion of the image unfocused, and the output arrangement displays the at least the selected portion and the remaining portion.

9. The device according to claim 1, wherein the processor enlarges at least a selected portion of the image, and the output arrangement displays the selected portion of the image.

10. The device according to claim 1, wherein the image is displayed in a predetermined orientation and position with respect to the output arrangement.

11. The device according to claim 10, wherein the predetermined orientation is an alignment of X- and Y-axes of the image with X- and Y-axes of the output arrangement.

12. The device according to claim 11, wherein the predetermined position is an intersection of the X- and Y-axes of the output arrangement.

13. The device according to claim 1, wherein the image includes a barcode.

14. The device according to claim 1, wherein the imaging arrangement is a digital camera and the output arrangement is a display screen.

15. A method comprising the steps of:
obtaining an image;
processing the image to determine a corresponding status of the image as a function of at least a predetermined decodability parameter;
displaying the image and a feedback signal of the corresponding status; and
adjusting the displayed image as a function of the corresponding status.

16. The method according to claim 15, wherein the feedback signal includes at least one of a visual and an audible indicator.

17. The method according to claim 16, wherein the visual indicator includes at least one of a light flash, a color change, an icon, a symbol, a floating level over a displayed range and a number.

18. The method according to claim 16, wherein the audible indicator is a tone varying in at least one of frequency, volume and pitch.

19. The method according to claim 15, wherein the predetermined decodability parameter is at least one of (i) a parameter indicative of a focus level of the image, (ii) a parameter indicative of whether the entire image is within an image capture field of the imaging arrangement, (iii) a parameter indicative of whether the image is ready for further processing.

20. The method according to claim 15, wherein the displaying step includes the following substeps:
focusing at least a selected portion of the image leaving a remaining portion of the image unfocused; and
displaying the at least the selected portion and the remaining portion.

21. The method according to claim 20, wherein the focusing step includes the following substeps:
mapping image pixels to display pixels in a one-to-one ratio for the selected portion.

22. The method according to claim 15, wherein the displaying step includes the following substep:
centering the image on the output arrangement.

23. The method according to claim 15, wherein the displaying step includes the following substeps:
resizing at least a selected portion of the image to a predetermined size; and
displaying the selected portion.

24. A device, comprising:
an imaging means for obtaining an image;
a processing means for processing the image to determine a corresponding status of the image as a function of at least one predetermined decodability parameter; and
an output means for displaying the image and a feedback signal of the corresponding status.
